(19) United States
(12) Patent Application Publication
(10) Pub. No.: US 2003/0071932 A1
(43) Pub. Date: Apr. 17, 2003

(54) Image displaying and picking-up device

(76) Inventor: Yasushi Tanigaki, Sakura-City (JP)

Correspondence Address: Eric Bram, Corporate Patent Counsel, Philips Electronics North America Corporation, 580 White Plains Road, Tarrytown, NY, 10591, US

(21) Appl. No.: 09/958,709

(22) PCT Filed: Feb. 9, 2001
(86) PCT No.: PCT/EP01/01507

(30) Foreign Application Priority Data
Feb. 22, 2000 (JP) 44470/2000

(51) Int. Cl. G02F 1/1335

(52) U.S. Cl. 349/61

(57) ABSTRACT

Image displaying and picking-up device having an imgae picking-up component in the backside of the liquid crystal panel.

### TECHNICAL FIELD

The invention relates to an image displaying and picking-up device having an image picking-up component in the backside of the liquid crystal panel.

### BACKGROUND OF THE INVENTION

Recently, it has become possible to transmit image signals bi-directionally owing to the communication technology improvement. Accordingly, image displaying and picking-up devices such as TV phones have been commonly available. These image displaying and picking-up devices contain an image picking-up component (e.g. CCD) for picking up or capturing the image of the local user himself or herself who is using that device and a display monitor for displaying the face of the remote user to whom the local user is talking. By the means of these component and monitor, both users who are remotely talking each other can look at the face of the respective opposite users.

However, for the above-described image displaying and picking-up devices, there is a drawback that so-called eye contact (eye contact is to look at the party's eye each other) can not be implemented since the image picking-up component is provided at the outside of the monitor.

Japan Patent Application No. 1990-113989 discloses an image displaying and picking-up device using a half mirror in order to overcome the above-described drawback. The disclosed device may provide the eye contact but still has a problem that the size of that device may be forced to become large because the half mirror must be mounted diagonally against the liquid crystal panel.

Therefore, it is an objective of this invention to provide a compact image displaying and picking-up device in size.

### SUMMARY OF THE INVENTION

An image displaying and picking-up device in accordance with the invention to achieve the above objective comprises a liquid crystal panel, an image picking-up component located at the backside of the said liquid crystal panel, a light shutter, located between the said liquid crystal panel and the said image picking-up component, having a first mode for passing a certain amount of the light and a second mode for passing the less amount of the light than the said certain amount of the light passed in the said first mode and a switching means for switching a portion of the said light shutter to one of the said first and second modes wherein the said portion of the light shutter overlaps with the image picking-up component in such direction that the said image picking-up component may pick up images.

By the switching of the light shutter between the first and second modes, the amount of the lights that are passed through the light shutter may vary. Thus, when the image of the local user being present in front of the liquid crystal panel is captured by the image picking-up component, as for the light shutter, the portion overlapping with the image picking-up component in such direction that the image may be captured may be set to the first mode to pass the light and at the same time, as for the liquid crystal panel, the portion overlapping with the image picking-up component in such direction that the image is captured may be set to a mode for passing the light as well. In such way, a light transparent area may be formed between the image picking-up component and the local user, so that the image of the local user can be captured by the image picking-up component.

On the other hand, when the image of the remote user is displayed on the liquid crystal panel, the light shutter may be set to the second mode to pass the less amount of the light. The operations for capturing the local user image with the image picking-up component and for displaying the remote user on the liquid crystal panel will be described later.

The inventive device may not need to arrange the light shutter diagonally against the liquid crystal panel but may locate it in parallel with the liquid crystal panel. Accordingly, all of the parts constructing the image displaying and picking-up device can be arranged compactly and efficiently in space, which may be resulted in a smaller size of the device itself.

The image displaying and picking-up device in accordance with the invention may preferably provide a backlight means for emitting red, green and blue lights toward the liquid crystal panel from the backside of the liquid crystal panel. By providing this backlight means, the liquid crystal panel can be constructed as a transmissive panel that can display color images on it using the light from backlight means.

Additionally, the image displaying and picking-up device in accordance with the invention may preferably provide a first light reflection member for reflecting the light emitted by the backlight means toward the crystal panel. With the first light reflection member, the usage efficiency of the light emitted by the backlight means may be improved.

Besides, the light shutter and the first light reflection member provided with the image displaying and picking-up device in accordance with the invention may be preferably constructed integrally. Such integral structure of the light shutter and the first light reflection member may contribute to a simplified structure of the parts used in the image displaying and picking-up device.

Moreover, the image displaying and picking-up device in accordance with the invention may preferably provide a second light reflection member located at the backside of the said first light reflection member. With the second light reflection member, the usage efficiency of the light emitted by the backlight means may be further improved.

Furthermore, the backlight means provided with the image displaying and picking-up device in accordance with the invention may comprise either LEDs or fluorescent lamps for emitting red, green and blue lights respectively. With the LED, the size of the backlight can be made compact, and with the fluorescent lamp, the cost of the backlight means can be decreased.

Furthermore, the light shutter provided with the image displaying and picking-up device in accordance with the invention may preferably comprise polymer dispersed liquid crystal materials, which may lead to a high speed switching of the light shutter.

As described above, a reflection type of liquid crystal panel can be constructed by providing a backlight means for emitting red, green and blue lights toward the liquid crystal panel. However, the image displaying and picking-up device in accordance with the invention may comprise a red reflection member for reflecting red components of light, a green reflection member for reflecting green components of light and a blue reflection member for reflecting blue components of light rather than the above-disclosed backlight means. By providing the red reflection member, the green reflection and the blue reflection member, the liquid crystal panel can be constructed as a reflective panel that can display color images on it by reflecting the external lights at these three reflection members.

Furthermore, the liquid crystal panel provided by the image displaying and picking-up device in accordance with the invention may be structured such that the red, green and blue reflection members may be organized either in multiple different layers or in a single layer on the liquid crystal panel.

Moreover, the image displaying and picking-up device in accordance with the invention may preferably comprise a light absorption member for absorbing lights that have passed through the liquid crystal panel, so that the contrast level of the displayed images can be made higher.

Finally, the liquid absorption member and the light shutter means provided by the image displaying and picking-up device in accordance with the invention may preferably be integrally constructed, so that the structure of the parts used in the device can be simplified.

### BRIEF DESCRIPTION OF THE DRAWINGS

FIG. 1 is a schematic front view of a TV phone 1 in accordance with the first embodiment of the invention;

FIG. 2 is a schematic side view of the TV phone 1 as depicted in FIG. 1;

FIG. 3 is a schematic illustration of the vertical cross section of the liquid crystal panel 3 as depicted in FIG. 1 as well as such various components as backlight 5 etc mounted on the backside of the liquid crystal panel 3;

FIG. 4 is a schematic front view of the liquid crystal panel 3 and the backlight 5;

FIG. 5 is a schematic illustration showing an exemplary implementation where three light sources are integrated into one light source;

FIG. 6 is a schematic enlarged cross sectional view of a portion of the reflection member 6 especially related with lens 7;

FIG. 7 is a block diagram of timing of movements of various functions of the TV phone 1 as depicted in FIG. 1;

FIG. 8 is a schematic enlarged illustration of the vicinity of the ITO electrodes 64 and 65 in the state of no voltage charged between ITO electrodes 64 and 65;

FIG. 9 is a schematic enlarged illustration of the vicinity of the ITO electrodes 64 and 65 in the state of a certain voltage charged between ITO electrodes 64 and 65;

FIG. 10 is a schematic cross sectional view of a TV phone 100 in accordance with the second embodiment of the invention;

FIG. 11 is a schematic enlarged illustration of the red reflection layer 110, the green reflection layer 120 and the blue reflection layer 130;

FIG. 12 is a schematic enlarged illustration of the portion, oppositely facing with the lens 7, of the light absorption layer 140 as depicted in FIG. 10;

FIG. 13 is schematic enlarged illustration of the microcapsule 141a;

FIG. 14 is a schematic illustration showing the situation where the light passes through the red reflection layer 110, the green reflection layer 120, the blue reflection layer 130 and the light absorption layer 140;

FIG. 15 is a schematic enlarged illustration of the vicinity of the two ITO electrodes 143 in the state of a certain voltage charged between them;

FIG. 16 is a schematic cross sectional view of an implementation of a liquid crystal panel providing three reflection members, each of which reflect red, green or blue light, onto a single reflection layer; and

FIG. 17 is a schematic enlarged illustration of the reflection member 161.

### DETAILED DESCRIPTION OF THE INVENTION

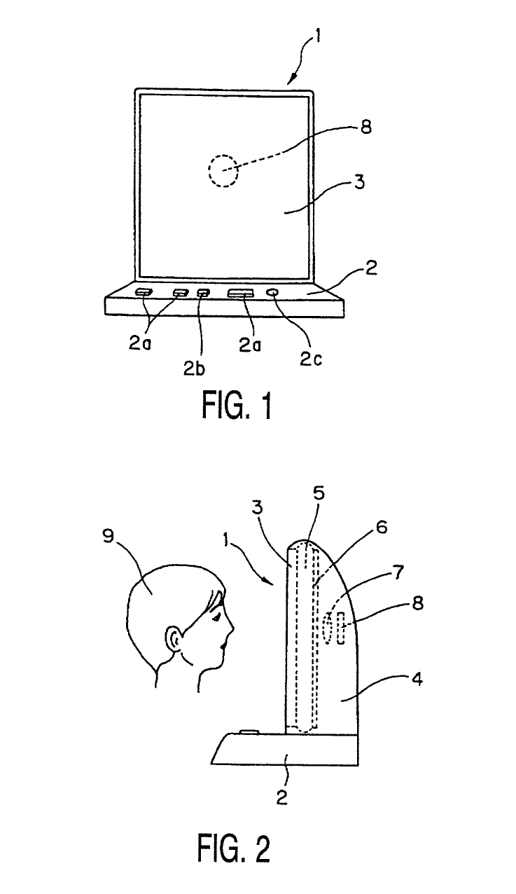

FIG. 1 illustrates a TV phone in accordance with the first embodiment of the invention and FIG. 2 shows a side view of this TV phone.

The TV phone 1 as illustrated in FIG. 1 includes a base 2 having various operation buttons 2a, a speaker 2b and microphone 2c. A liquid crystal panel 3 for displaying images is mounted on the upper portion of the base 1. The back of the liquid crystal panel 3 is covered with a cover 4 as illustrated in FIG. 2. A backlight 5 is provided within the cover 4, and further in the backside of the backlight 5, a reflection member 6 for reflecting the light emitted from the backlight 5 is provided. The function of the reflection member 6 will be described later in detail. Besides, in the backside of the reflection member 6, a lens 7 and a CCD camera 8 for receiving images through the lens 7 are provided. In FIG. 2, a local user 9 communicating with another person (referred to as “a remote user” herein) by using the TV phone 1 is also shown. The CCD camera 8 is used to image the local user with colors rather than monochrome. Color images captured by the CCD camera 8 may be displayed on the TV phone used by the remote user.

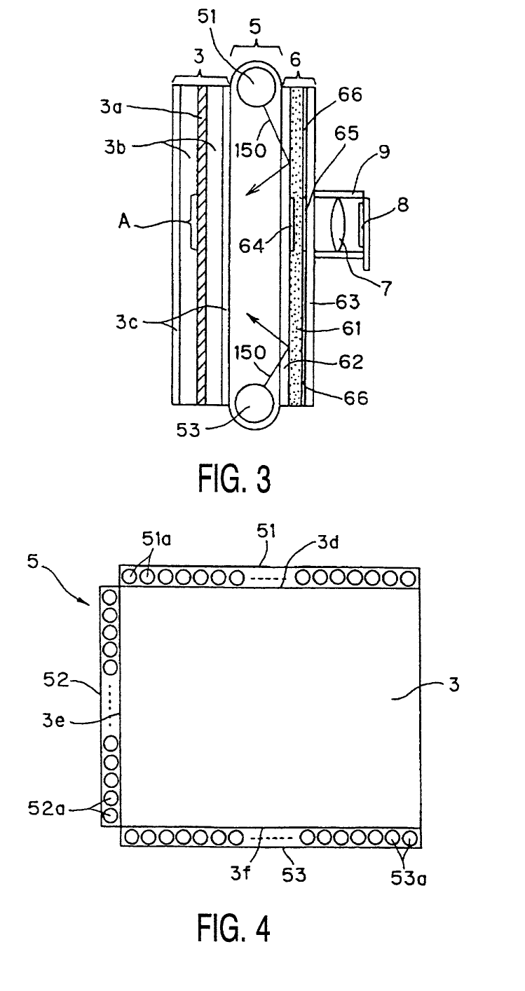

FIG. 3 illustrates a vertical cross sectional view of the liquid crystal panel 3 and various components including backlight 5 that are mounted on the backside of the liquid crystal panel 3, and FIG. 4 illustrates a front view (in terms of the liquid crystal panel) of the liquid crystal panel 3 and the backlight 5.

The liquid crystal panel 3, as illustrated in FIG. 3, includes a liquid crystal layer 3a (shown as hatched in FIG. 3) and a pair of glass substrates 3b sandwiching the liquid crystal layer 3a between them. Each of the pair of glass substrates 3b comprises ITO (indium-tin-oxide) electrodes (not shown) for charging a certain voltage onto the liquid crystal layer 3a. In this embodiment, an optical compensation birefringence (OCB) type of liquid crystal material is used, the response speed of which is fast. There are several types of materials having a fast response speed, including a type of anti-ferroelectric liquid crystal (AFLC). As an alternative to the above OCB type, an AFLC type may be used. By using a fast-response type of material, it may be possible to increase the frame frequency of the images displayed on the liquid crystal panel 3. Respective polarizing plates 3c are formed on each of the two glass substrates 3b.

Although the above-described liquid crystal panel 3 is designed to display color images, it does not comprise any color filter corresponding to red, green and blue light respectively. The reason will be described below.

Herein, the assumption is made that liquid crystal panel 3 had a color filter. In the case, when the image of the local user 9 (see FIG. 2) is captured by means of CCD camera 8, the light coming into the CCD camera 8 would be the light that has already passed through said color filter of the liquid crystal panel 3. As above noted, the CCD camera 8 itself contains color filters because it is designed to create the color image of the local user 9. Accordingly, if the liquid crystal panel 3 had any color filter, the light coming into the CCD camera 8 might be the light that had passed through the color filter of the liquid crystal panel 3 before passing through the color filter of the CCD camera itself. Because of such duplication of filtering, the color information of the image of the local user 9 may not be communicated appropriately. Thus, the liquid crystal panel 3 must have no color filter on it to correctly transmit the color information of the image of the local user 9.

As just described, the liquid crystal panel 3 is designed to display color images, but it does not have any color filter. Accordingly, as will be explained below, the backlight 5 mounted in the backside of the liquid crystal panel 3 of the TV phone 1 in FIG. 1 should be designed so as to display color images on the liquid crystal panel 3 that contains no color filter.

As illustrated in FIG. 4, the backlight 5 comprises a red light source 51 for emitting red lights, a green light source 52 for emitting green lights and a blue light source 53 for emitting blue lights. By means of these red, green and blue light sources 51, 52 and 53, the liquid crystal panel 3 can display color images without any color filter on itself. How to display color images on the liquid crystal panel 3 will be described later. A red light source 51 is formed by a plurality of red LEDs (light emitting diodes) 51a that are aligned along the upper side 3d of the liquid crystal panel 3, a green light source 52 is formed by a plurality of green LEDs 52a that are aligned along the left side 3e of the liquid crystal panel 3, and a blue light source 53 is formed by a plurality of red LEDs 53a that are aligned along the lower side 3f of the liquid crystal panel 3. By using LEDs to form red, green and blue light sources as mentioned above, compactness of the backlight 5 could be obtained. In this embodiment, each of red, green and blue light sources is formed separately each other, but alternatively these three light sources may be integrated into a single light source.

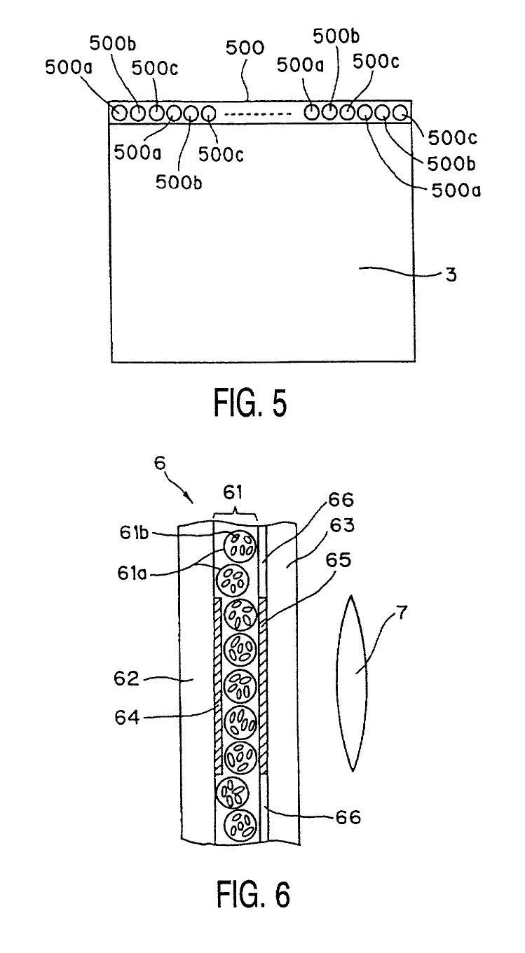

FIG. 5 illustrates an example of a single light source that combines three light sources.

A light source 500 comprises red LEDs 500a, green LEDs 500b and blue LEDs 500c. Each of these color LEDs is arranged alternatively in the order of red, green and blue. The backlight 5 can have various structures such as illustrated in FIG. 4 and FIG. 5. However, it is assumed that this embodiment uses the backlight structure shown in FIG. 4. Additionally, all of the red, green and blue light sources in this embodiment utilize the LED, but instead of the LED, fluorescent lamps may be used to decrease the cost of the light source more than in case of the LED.

Now referring back to FIG. 3, the reflection member 6 mounted in the backside of the backlight 5 comprises a liquid crystal layer 61 (shown as hatched) for reflecting lights (this layer will be simply referred to as “a reflective liquid crystal layer” herein) and a pair of glass substrates 62 and 63 for sandwiching the reflective liquid crystal layer 61 between them. Behind the reflection member 6, a CCD camera 8 is positioned to receive the light passing through a lens 7 that is supported by a lens carrier 9.

FIG. 6 illustrates a portion of the reflection member 6 which is close to the lens 7. The reflective liquid crystal layer 61 contains a plurality of microcapsules 61a, each of which contains a plurality of nematic liquid crystal materials 61b that are dispersed within the microcapsule 61a. A nematic liquid crystal material 61b is an example of a polymer dispersed liquid crystal material that is used in the invention. The nematic liquid crystal materials 61b are oriented along the wall surface of the microcapsule 61a when they are not charged, but are oriented along the direction of the electric field when charged. In addition, for the glass substrates 62, 63 provided in the reflection member 6, their respective portions that are facing with the lens 7 are formed with ITO electrodes 64 and 65 (shown as hatched) for charging a certain voltage upon the reflective liquid crystal layer 61. Also, the glass substrate 63, which is one of the two glass substrates 62, 63 and located on the side near to the lens 7, comprises a light reflection coat 66 (which is a second reflection member according to the invention). The light reflection coat 66 is formed so as to surround the ITO electrode 65 as illustrated in FIG. 3 and FIG. 6. In this example, the material of the reflection coat 66 is aluminum. Thus, as illustrated in FIG. 3, the reflection member 6 constructed as above explained may have a function to reflect the light 150 emitted from each of the light sources 51, 52 and 53 toward the liquid crystal panel 3. This function will be further described later. It should be noted that the reflective liquid crystal layer 61 corresponds to a combination of a light shutter and a first light reflection member in accordance with the invention, and a portion of the reflective liquid crystal layer 61 positioned between ITO electrodes 64 and 65 corresponds to the light shutter in accordance with the invention.

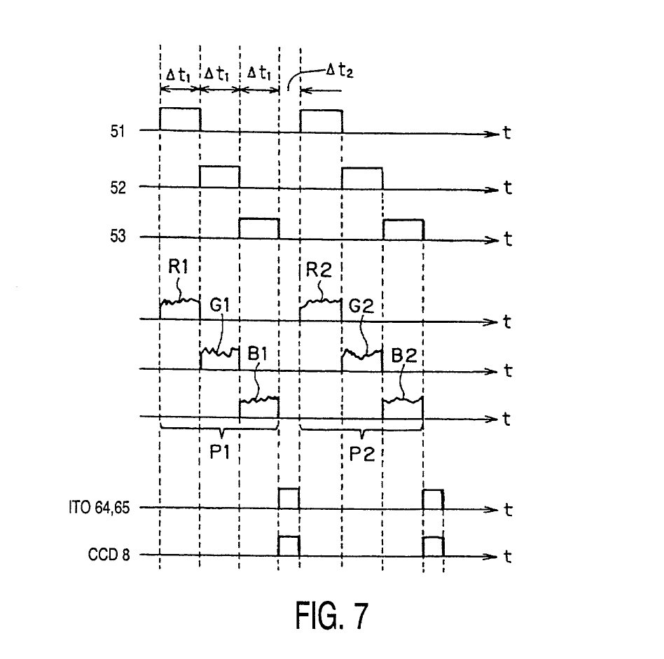

Now, the operation of the TV phone 1 as constructed above will be explained. FIG. 7 illustrates the timing relationship of operations of the TV phone 1. As shown in FIG. 7, red, green and blue light sources 51, 52 and 53 are asserted to emit its respective color light in sequence during each separate time period. When these light sources are asserted, the image of the remote user to whom the local user of the liquid crystal panel 3 is talking may be displayed on the concerned liquid crystal panel 3 (See FIG. 1). At this time, the voltage to be charged between ITO electrodes 64 and 65 is kept to be zero (namely the voltage between them is not charged).

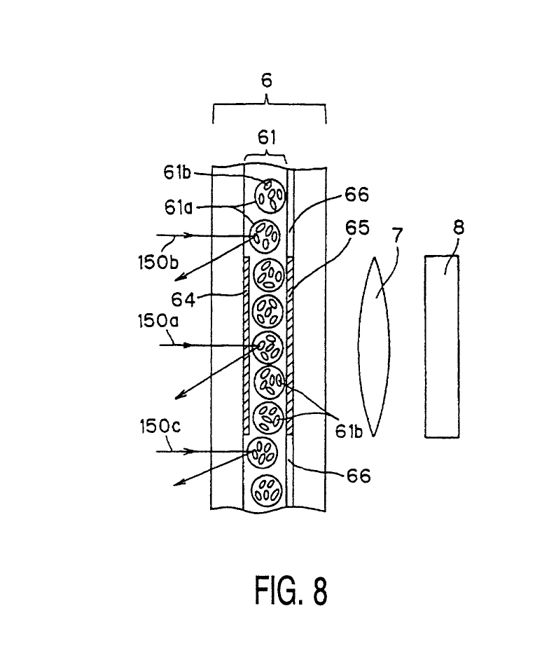

FIG. 8 illustrates an enlarged view of the vicinity of ITO 64 and 65 when the voltage between ITO 64 and 65 is not charged. ITO 64 and 65 (which correspond to switching means in accordance with the present invention) are located to oppositely face with the lens 7 within the reflective liquid crystal layer 61, so that the alignment direction of the nematic liquid crystal materials 61b that are sandwiched between ITO electrodes 64 and 65 may be alternatively changed in response to the voltage state of charge or no charge. On the other hand, because there is no ITO electrodes 64 and 65 in the portion of the reflective liquid crystal layer 61 which faces the reflective coat 66, that portion may be always kept in no voltage state whether the voltage will be charged between ITO electrodes 64 and 65 or not. Accordingly, nematic liquid crystal materials 61b at the portion of the reflective liquid crystal layer 61 which faces the reflective coat 66 will be always aligned randomly as a whole along the wall of the microcapsule 61a. Also, when the voltage is not charged between ITO electrodes 64 and 65, nematic liquid crystal materials that are sandwiched between ITO electrodes 64 and 65 are aligned randomly as a whole as well as nematic liquid crystal materials 61b in the portion of the reflective liquid crystal layer 61 which faces the reflective coat 66. Thus, when the voltage is not charged between ITO electrodes 64 and 65, nematic liquid crystal materials 61b are aligned in the random direction across all over the reflective liquid crystal layer 61. Accordingly, incident lights 150a emitted from each of the light sources 51, 52 and 53 and coming into the area defined by ITO 64 and 65, as well as incident lights 150b and 150b coming into the area positioned outside ITO 64 and 65, may be scattered due to the function of nematic liquid crystal materials 61b aligned in the random direction. Therefore, most of the lights coming into the light reflection member 6 may be reflected toward the liquid crystal panel 3 (See FIG. 3). Thus, in a no charge state when no voltage is charged between ITO electrodes 64 and 65, the reflective liquid crystal layer 61 is set to a reflection mode wherein most of the lights coming into the light reflection member 6 may be reflected toward the liquid crystal panel 3. Once the reflective liquid crystal layer 61 is set to a reflection mode, the light emitted from the backlight 5 can be passed into the liquid crystal panel 3 effectively. In this embodiment, since the reflection coat 66 is provided in the backside of the reflective liquid crystal layer 61, incident lights 150a, 150b and 150c coming into the reflection member 6 can be reflected toward the liquid crystal panel 3 more effectively. By means of the reflection coat 66, the efficiency for use of the light from the backlight 5 can be further improved.

As described above, each of red, green and blue light sources 51, 52 and 53 is asserted in sequence when the reflective liquid crystal layer 61 is being set to a reflection mode as illustrated in the timing chart of FIG. 7. When the red light source 51 of the three light sources 51, 52 and 53 is asserted, a red light is emitted from that red light source 51. The red light 150 (see FIG. 3) emitted from the red light source 51 will be efficiently reflected toward the liquid crystal panel 3 due to the function of the reflection member 6 because the reflective liquid crystal layer 61 is being set to a reflection mode. Besides, while the red light source 51 is being asserted, a red signal R1 representing a red color component among one frame of image signal P1 representing the image of the remote user will be transmitted to the ITO electrode (not shown) of the liquid crystal panel 3, so that a certain voltage will be charged upon a specific portion of the liquid crystal layer 3a corresponding to the respective pixel. Thus, a pass-through ratio representing how much the red light 150 emitted from the red light source 51 passes through the liquid crystal layer 3a will vary for each portion of liquid crystal layer 3a corresponding to each pixel, so that the red color image among the one frame of the color image will be displayed on the liquid crystal panel 3. The red color image corresponds to the red signal R1.

Upon deassertion of the red light source 51, the red image will disappear from the liquid crystal panel 3 and a green light source 52 will be asserted instead of the red light source 51 as illustrated in FIG. 7. While the green light source 52 is being asserted, a green signal G1 representing a green color component among one frame of the image signal P1 representing the image of the remote user will be transmitted to the ITO electrode (not shown) of the liquid crystal panel 3, so that a certain voltage corresponding to the green signal G1 will be charged upon the liquid crystal layer 3a of the liquid crystal panel 3 and accordingly the green color image, corresponding to the green signal G1, of the one frame of the color image will be displayed on the liquid crystal panel 3.

Upon deassertion of the green light source 52, the green image will disappear from the liquid crystal panel 3 and a blue light source 53 will be asserted instead of the green light source 52 as illustrated in FIG. 7. While the blue light source 53 is being asserted, a blue signal B1 representing a blue color component among one frame of the image signal P1 representing the image of the remote user will be transmitted to the ITO electrode (not shown) of the liquid crystal panel 3, so that a certain voltage corresponding to the blue signal B1 will be charged upon the liquid crystal layer 3a of the liquid crystal panel 3 and accordingly the blue color image, corresponding to the blue signal B1, of the one frame of the color image will be displayed on the liquid crystal panel 3.

In such way as described above, color components of red, green and blue for one frame of the color image are displayed in an alternate sequence rather than simultaneously. However, each time period Δt1 when each of red, green and blue light sources is asserted is about 7 msec (milliseconds). That is to say, since each image of red, green and blue color will be displayed sequentially in about 21 msec, human eyes cannot distinguish each color separately due to the effect of afterimage for human eyes and the resolving power of human eyes. As a result, human eyes see a color mixture comprising red, green and blue colors. Accordingly, even though each color image corresponding to red, green and blue respectively is separately displayed, human eyes can see a complete color image representing one frame. After an image of one frame represented by red signal R1, green signal G1 and blue signal B1 has been displayed on the liquid crystal panel 3 as explained above, an image of one frame represented by red signal R2, green signal G2 and blue signal B2 will be displayed on the liquid crystal panel 3 as illustrated in FIG. 7, and then the next one frame image will be displayed and so on. Thus, each color image corresponding each frame will be displayed sequentially. The liquid crystal panel 3 mounted on the TV phone 1 is constructed as a so-called transmissive liquid crystal panel that utilizes the light of backlight 5 to display images.

At the same time when the image of the remote user is being displayed in the liquid crystal panel 3, the image of the local user himself or herself 9 (see FIG. 2) may be captured by the CCD camera 8 and the captured image is transmitted to the remote user in order to communicate each other. The CCD camera 8 is mounted in the backside of the liquid crystal panel 3. Therefore, when some image is being displayed on the liquid crystal panel 3, the CCD camera 8 cannot capture the image of the local user who is in front of the liquid crystal pane 3 due to the interruption of the light that are emitted from each light source 51, 52 and 53. Thus, this embodiment of the invention provides a time period Δt2 when all of red, green and blue light sources 51, 52 and 53 are deasserted (namely set to off) not to display any image but the CCD camera 8 is asserted instead. It should be noted that at a time period Δt1 when any light source of red, green and blue 51, 52 and 53 is asserted, no voltage is charged between ITO electrodes 64 and 65 included in the reflection member 6 as explained above, but during a time period Δt2, a certain voltage will be charged between those ITO electrodes 64 and 65.

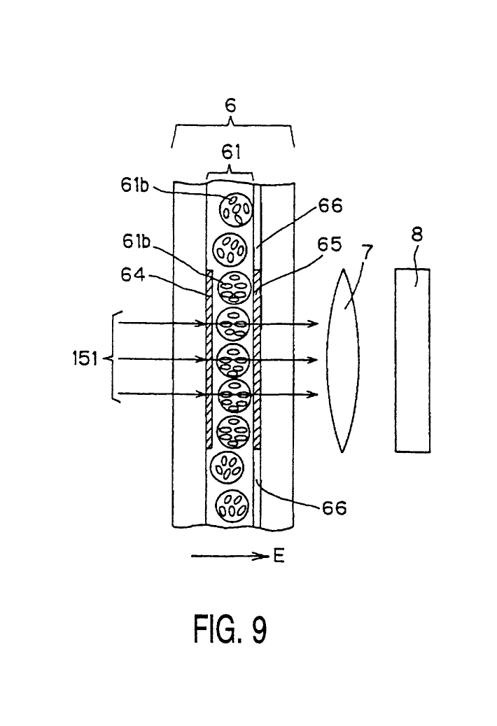

FIG. 9 illustrates an enlarged view of the vicinity of ITO electrodes 64 and 65 when a certain voltage is charged between those ITO electrodes 64 and 65. Since the portion of the reflective liquid crystal layer 61 which faces the reflective coat 66 is always kept in a no voltage state whether any voltage may be charged between those ITO electrodes 64 and 65 or not, the nematic liquid crystal materials 61b facing the reflective coat 66 remain oriented in the random direction as shown in FIG. 9. Accordingly, the portion of the reflective liquid crystal layer 61 which faces the reflective coat 66 remains in a reflection mode to reflect any light. On the other hand, nematic liquid crystal materials 61b that exist in the area between ITO electrodes 64 and 65 will be aligned toward the electric field direction E when a certain voltage is charged. Accordingly, when a certain voltage is charged between ITO electrodes 64 and 65, only nematic liquid crystal materials 61b that exist in the area between ITO electrodes 64 and 65 are aligned toward the electric field direction E. Therefore, the state of the portion, oppositely facing with the lens 7, of the reflective liquid crystal layer 61 may be changed from a light reflection mode (namely a first mode in accordance with the invention) to a transparent mode (namely a second mode in accordance with the invention) for passing through the light transparently. At the same time, the portion A (see FIG. 3), oppositely facing with the lens 7, of the liquid crystal layer 3a of the liquid crystal panel 3 may become in a light transparent mode as well. Thus, as illustrated in FIG. 9, external lights 151 can reach the reflective liquid crystal layer 61 of the reflection member 6 after having passed through the liquid crystal panel 3. The external lights 151 that have reached the reflective liquid crystal layer 61 may then pass through without any scattering since the nematic liquid crystal materials 61b are aligned toward the electric field direction E, and may b finally be received by the CCD camera 8 via lens 7. In such way, the image of the local user 9 can be captured during the time period Δt2. Since the time period Δt2, about 2 msec, is very short, the local user 9 cannot distinguish the intermission between an image P1 and an image P2 and the eyes of the local user 9 may continue to see the image P1 and the image P2 as if they were contiguous. The image of the local user 9 obtained during the time period Δt2 may be displayed on the remote TV phone used by the remote user whom the local user 9 is talking to.

Since the CCD camera 8 is mounted at the backside of the liquid crystal panel 3 via the backlight 3 and the reflection member 6 as illustrated in FIG. 3, the line of sight of the local user 9 can be directed toward the CCD camera 8 via the liquid crystal panel 3, backlight 5, the reflection member 6 and lens 7 if the local user 9 look at the image displayed on the liquid crystal panel 3. Thus when the image of the local user 9 picked up by the CCD camera 8 is displayed on the display monitor of the remote TV phone of the remote user, the line of sight of the local user 9 displayed on that remote display screen may coincide with the line of the sight of the remote user. In the same manner, the line of sight of the remote user displayed on the liquid crystal panel 3 may coincide with the line of the sight of the local user 9. Therefore, the local user 9 can keep an eye contact with the remote user through the TV phones on both sides.

In the implementation of the above-explained TV phone 1, the reflection member 6 mounted in front of the CCD camera 8 via lens 7 is placed in parallel with the liquid crystal panel 3 via the backlight 5, so that the backlight 5 and the reflection member 6 can be mounted within the cover 4 compactly, which may be resulted in the compact size of the TV phone 1.

It should be noted that although the TV phone 1 is provided with the backlight 5 comprising red, green and blue light sources 51, 52 and 53, it may be possible to use a type of backlight emitting a white light instead of such backlight 5 if a monochrome image rather than a color image is accepted to be displayed on the TV phone 1.

In the above-described implementation of the TV phone 1, the reflection coat 66 provided on the reflection member 6 serves to improve the efficiency of the use of the light emitted from the backlight 5 and display the image having enough amount of lightness on the TV phone 1. However, in the situation where the image having sufficient amount of lightness can be displayed on the TV phone without the reflection coat 66, such reflection coat 66 may be unnecessary.

Besides, although nematic liquid crystal materials are used as a material for the reflective liquid crystal layer 61 of the reflection member 6 provided on the TV phone 1, any other material than nematic liquid crystal such as cholesteric liquid crystal may be alternatively used.

As described above, the reflection member 6 provided on the TV phone 1 plays a role on reflecting the light of backlight 5 toward the liquid crystal panel 3. The reflection member 6 has also ITO electrodes 64 and 65 on the portion oppositely facing with the lens 7 in order to charge the voltage. By means of those ITO electrodes 64 and 65, the portion, oppositely facing with the lens 7, of the reflection member 6 serves as a light shutter to reflect the light of the backlight 5 when images are displayed on the TV phone 1 and, on the other hand, to pass through external lights when the image of the local user 9 is to be captured by the CCD camera 8. Thus the reflection member 6 has a function of light shutter in addition to a function to reflect the light of the backlight 5 toward the liquid crystal panel 3. Thus, only by providing such ITO electrodes on the reflection member 6, it is possible to give a light shutter function as well as a light reflection function to the reflection member 6 so that the structure of the parts used on the TV phone 1 can be simplified. If it is not possible to give both functions of light reflection and light shutter to the reflection member 6 due to, for example, material constraints, it may be possible to provide a light reflection member and a light shutter member separately.

Having described the TV phone 1 displaying images by using the light of the backlight 5, now another TV phone displaying images by using external lights will be described.

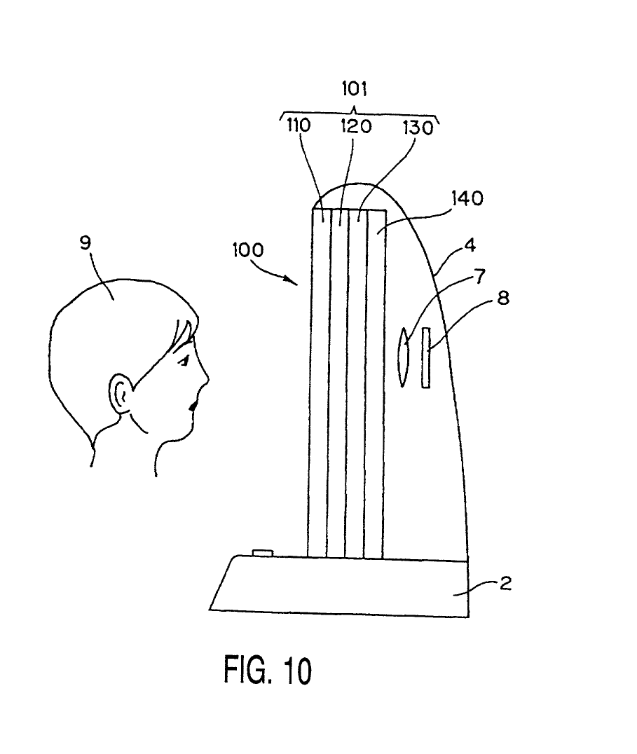

FIG. 10 illustrates a cross section of the TV phone 100 in accordance with the second embodiment of the invention. The TV phone 100 comprises a base 2 having several operation buttons. A liquid crystal panel 101 for displaying images is mounted on the upper portion of the base 2. In the backside of the liquid crystal panel 101 a light absorption layer 140 for absorbing the light is provided. Behind the light absorption 140, a CCD camera 8 via a lens 7 is provided. A cover 4 covers the light absorption layer 140, the lens 7 and the CCD camera 8. The liquid crystal panel 101 of the TV phone 100 comprises a red reflection layer 110, a green reflection layer 120 and a blue reflection layer 130. Functions of each of these layers will be explained below.

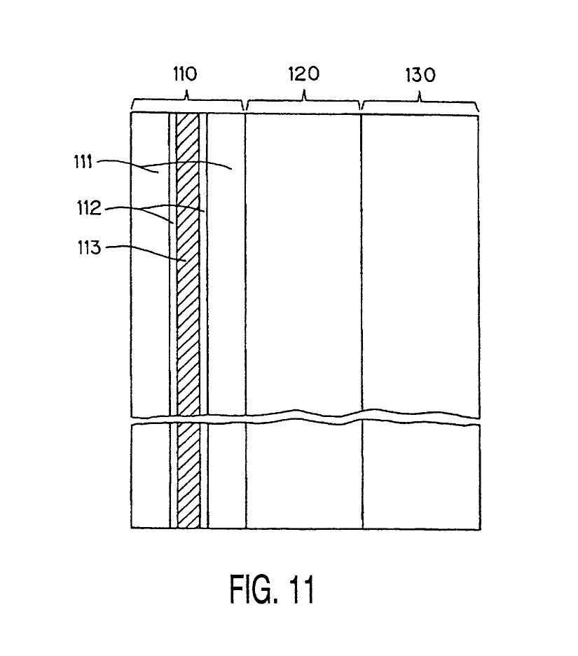

FIG. 11 illustrates an enlarged view of a red reflection layer 110, a green reflection layer 120 and a blue reflection layer 130. Herein, only the red reflection layer 110 is shown in detail. These red reflection layer 110, green reflection layer 120 and blue reflection layer 130 are arranged in such manner that the green reflection layer 120 is located in the center between the red reflection layer 110 and the blue reflection layer 130 and these layers are attached each other with the transparent epoxy resin material.

The red reflection layer 110 comprises a pair of glass substrates 111 having ITO electrodes 112. Between these two glass substrates 111, a red reflective liquid crystal layer 113 for reflecting red components of the light is sandwiched. The red reflective liquid crystal layer 113 contains both nematic and cholesteric liquid crystal materials. Cholesteric liquid crystal materials form a spiral structure. The helical pitch of this spiral structure is adjusted to such length as to selectively reflect a red component of the light. Nematic liquid crystal materials and cholesteric liquid crystal materials may be aligned in the horizontal direction relative to the glass substrates 111 when any voltage is not charged on the liquid crystal layer 113. Accordingly, in a no voltage state, a light transparent mode for passing through the light is set for the liquid crystal layer 113. On the other hand, when a certain voltage is charged on the liquid crystal layer 113, nematic liquid crystal materials and cholesteric liquid crystal materials will tilt by a certain angle corresponding to the amount of the charged voltage, and accordingly the mode will be changed to a reflection mode for reflecting the light. Since the helical pitch of the spiral structure of the cholesteric liquid crystal materials is adjusted to such length as to selectively reflect a red component of the light, the liquid crystal layer 113 may selectively reflect only red components of the light in a reflection mode.

The green reflection layer 120 and the blue reflection layer 130 have the same structure as the red reflection layer 110. The difference among these three layers is that each helical pitch of the red reflection layer 110, the green reflection layer 120 and the blue reflection layer 130 is so adjusted to a respective length as to selectively reflect only a respective color component of each of theses layers. Thus, the liquid crystal panel 101 comprises the red reflection layer 110, the green reflection layer 120 and the blue reflection layer 130 that reflect independently their respective color components of red, green and blue. By providing the red reflection layer 110, the green reflection layer 120 and the blue reflection layer 130, the liquid crystal panel 101 can display color images.

In the backside of the liquid crystal panel 101 as structured above, a light absorption layer 140 is provided as illustrated in FIG. 10.

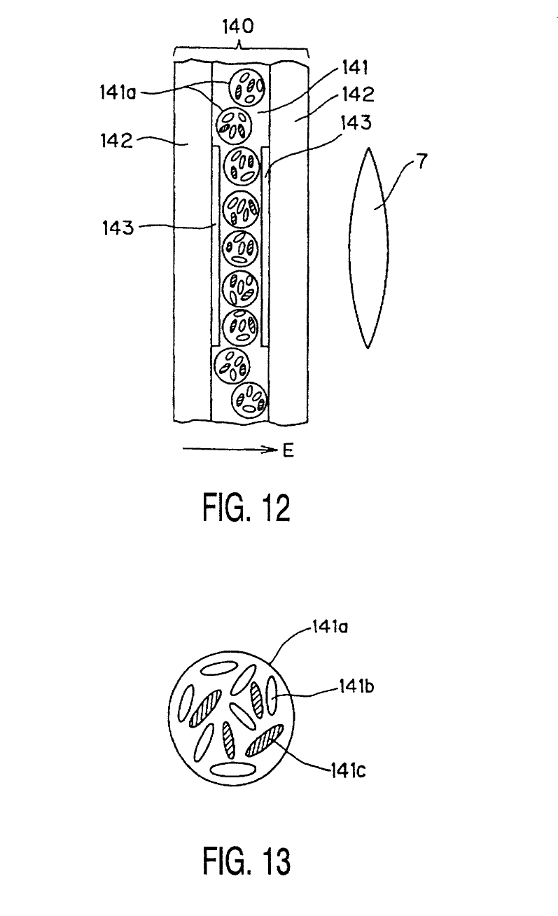

FIG. 12 illustrates an enlarged view of the portion, oppositely facing with the lens 7, of the light absorption layer 140 shown in FIG. 10. The light absorption layer 140 comprises a liquid crystal layer 141 and a pair of glass substrates 142 sandwiching the liquid crystal layer 141 between the pair of glass substrates 142. For the pair of glass substrates 142, ITO electrodes 143 (which correspond to the switching means in accordance with the invention) are formed only on its portion oppositely facing with the lens 7. The liquid crystal layer 141 comprises a plurality of microcapsules 141a that contain liquid crystal materials inside.

FIG. 13 illustrates an enlarged view of a microcapsule 141a. Inside of the microcapsule 141a, nematic liquid crystal materials 141b (shown as whitened) and black dichroism dye materials 141c (shown as hatched) are sealed. The nematic liquid crystal materials 141b (corresponding to polymer dispersed liquid crystal materials in accordance with the invention) are aligned along with the wall of the microcapsule 141a when no voltage is charged, whereas they are aligned toward the electric field direction E (namely toward the vertical direction against the substrates 142) when a certain voltage is charged. As for black dichroism dye materials 141c, they are aligned along with the wall of the microcapsule 141a when no voltage is charged as well as the nematic liquid crystal materials 141b but when a certain voltage is charged, they are aligned toward the electric field direction (namely toward the vertical direction against the substrates 142) by depending on the movement of the nematic liquid crystal materials 141b. In other words, nematic liquid crystal materials 141b and black dichroism dye materials 141c are aligned in the random direction against the substrates 142 when no voltage is charged but are aligned in the vertical direction against the substrates when some voltage is charged. When black dichroism dye materials 141c are aligned in the random direction against the substrates 142, an incident light coming into the light absorption layer 140 may be absorbed by black dichroism dye materials 141c, but when black dichroism dye materials 141c are aligned in the vertical direction against the substrates 142, an incident light coming into the light absorption layer 140 may be passed through the layer 140(FIG. 12 illustrates the situation when no voltage is charged between the two ITO electrodes 143).

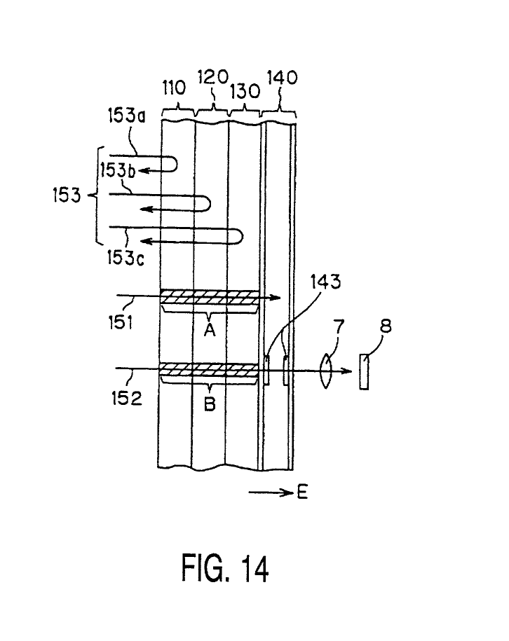

Now the operation of the TV phone 100 as above constructed will be explained. FIG. 14 illustrates the situation where lights are coming into the red reflection layer 110, the green reflection layer 120, the blue reflection layer 130 and the light absorption layer 140.

In order to display an image on the liquid crystal panel 101, it is required to charge, upon each of the red, green and blue liquid crystal layers 110, 120 and 130, an appropriate voltage corresponding to the signal R, G and B respectively representing red, green and blue components of the image. In response to the charged voltage, a light reflection rate for each of the red reflection layer 110, the green reflection layer 120 and the blue reflection layer 130 varies in accordance with the signals R, G and B respectively, and also such rate varies for each portion corresponding to each of pixels. As illustrated in FIG. 14, only red light components 153a of the external light 153 may be reflected by the red reflection layer 110, and the rest of the light, namely green light components 153b and blue light components 153c, may pass through the red reflection layer and then reach the green reflection layer 120. Then, only the green light components 153b of the green and blue light components may be reflected by the green reflection layer 120, and the rest of the light, namely the blue light components 153c, may pass through the green reflection layer 120 and then reach the blue reflection layer 130. Finally, the blue light components 153c may be reflected by the blue reflection layer 130. Thus, a complete color image of three color mixtures can be displayed through the reflection of each color components of red, green and blue against the red reflection layer 110, the green reflection layer 120 and the blue reflection layer 130 respectively.

Besides, in order to display a black color within one frame of the image, it is necessary to set to a transparent mode (non-reflection mode) only the area A (shown as hatched), corresponding to the specific pixel (that is intended to make it black), of each of the red reflection layer 110, the green reflection layer 120 and the blue reflection layer 130. By setting the area A to the transparent mode, the external light 151 may pass through the area A and reach the light absorption layer 140. When an image is displayed on the liquid crystal panel 101, no voltage is charged between the two ITO electrodes 143 of the light absorption layer 140, so that black dichroism dye materials 141c (see FIG. 12) may be aligned in the random direction all over the light absorption layer 140 and accordingly external light 151 may be absorbed by the light absorption layer 140. As a result the portion corresponding to the area A may appear black.

In such way as above explained, color images may be displayed. It is said that the liquid crystal panel 101 mounted on the TV phone 100 comprises a so-called light reflection type of liquid crystal panel that displays images by using external lights.

In order to obtain the image of the local user 9 with the CCD camera 8, it is required to set to a light transparent mode for passing through the light for the area B, oppositely facing with the lens 7, of the red reflection layer 110, the green reflection layer 120 and the blue reflection layer 130. With the light transparent mode for the area B, external light 152 may reach directly to the light absorption layer 140 after passing through the red reflection layer 110, the green reflection layer 120 and the blue reflection layer 130. At that time, a certain voltage should be charged on the two ITO electrodes 143 of the light absorption layer 140 in contrast with the time when images are displayed on the liquid crystal panel 101.

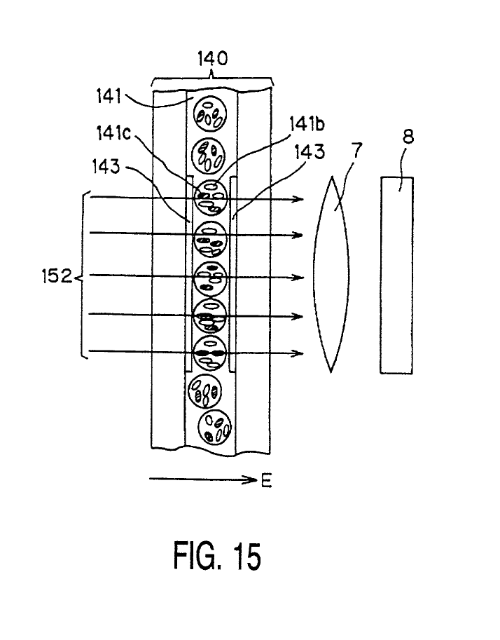

FIG. 15 illustrates an enlarged view of the vicinity of these two ITO electrodes 143 when a certain voltage is charged. When a certain voltage is charged between the two ITO electrodes 143, nematic liquid crystal materials 141b that are located between these two electrodes 143 are aligned toward the electric field direction E as shown in FIG. 14. At the same time, black dichroism dye materials 141c are also aligned toward the electric field direction E by depending on the movement of the nematic liquid crystal materials 141b. Accordingly, when a certain voltage is charged between the two ITO electrodes 143, only black dichroism dye materials 141c that are oppositely facing with lens 7 are aligned toward the electric field direction E (namely in the vertical direction against substrates 142). Thus, the external light 152 coming into the light absorption layer 140 may not be absorbed by the black dichroism dye materials 141c but reach the CCD camera 8 through the lens 7 after passing through the light absorption layer 140. In this way, the image of the local user 9 can be obtained. It can be understood that the portion, oppositely facing with lens 7, of the light absorption layer 140 plays a role of a light shutter to absorb external lights when images are displayed on the TV phone 100 but pass through external lights only when the image of the local user 9 is captured by the CCD camera 8.

Thus, it is possible to display the image of the remote user and also to pick up the image of user 9 himself or herself onto the CCD camera 8. It should be noted that the liquid crystal layer 141 corresponds to a combination of the light absorption member and the light shutter in accordance with the invention and the portion of the liquid crystal layer 141 that is present in the area between the two ITO electrodes 143 corresponds to the light shutter in accordance with the invention.

In the above-described implementation of the TV phone 100, the red reflection layer 110, the green reflection layer 120, the blue reflection layer 130 and the light absorption layer 140 that are located in front of the CCD camera 8 via the lens 7 are arranged closely and in parallel each other, so that the red reflection layer 110, the green reflection layer 120, the blue reflection layer 130 and the light absorption layer 140 can be mounted within the cover 4 compactly, which may be resulted in the compact size of the TV phone 100.

It should be also noted that the light absorption layer 140 provided on the TV phone 100 has not only a function to absorb external lights to display black colors but also has ITO electrodes 143 for charging an appropriate voltage on the portion that is oppositely facing with the lens 7 as illustrated in FIG. 12. With the ITO electrodes 143, the portion, oppositely facing with the lens 7, of the light absorption layer 140 serves□as a light shutter to absorb external lights when images are displayed on the TV phone 100, on the other hand, to pass through external lights only when the image of the local user 9 is captured by the CCD camera 8. Thus, the light absorption layer 140 has a function of displaying black colors by absorbing external lights and also has a light shutter function. Thus, only by providing ITO electrodes on the light absorption layer 140, it is possible to have not only a function to display blacks but also a light shutter function on this light absorption layer 140, and as a result, the structure of the parts used in the TV phone 100 can be simplified. It should be noted that it might be possible to separately provide a member for serving a function to display black colors and a member for serving a light shutter if it is not possible to provide such dual functions with the light absorption layer due to, for example, material constraints.

It should be further noted that although the liquid crystal panel 101 provided on the TV phone 100 in accordance with the second embodiment of the invention comprises the three reflection layers 110, 120 and 130 for reflecting respective red, green and blue lights, it may be possible to use, instead of the liquid crystal panel 101, an alternative liquid crystal panel comprising three reflection members that reflect a respective light of red, green and blue onto a single reflection layer.

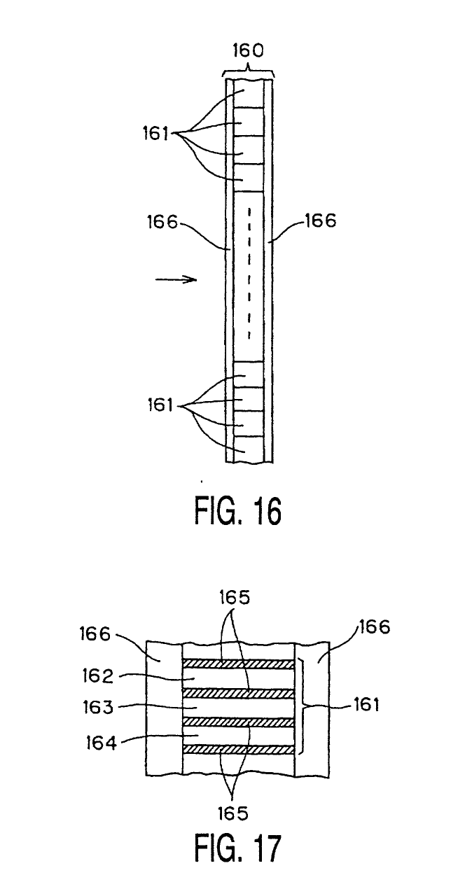

FIG. 16 illustrates a vertical cross section view of such alternative liquid crystal panel comprising three reflection members that reflect a respective light of red, green and blue onto a single reflection layer. The liquid crystal panel 160, as illustrated in FIG. 16, comprises a pair of glass substrates 166 on which ITO electrodes (not shown) are formed. A plurality of reflection parts 161 for reflecting lights are provided in the area between these two glass substrates 161. Each one of these reflection parts corresponds to a single pixel.

FIG. 17 illustrates an enlarged view of a reflection member 161. The reflection member 161 comprises a red reflection part 162 for reflecting red lights, a green reflection part 163 for reflecting green lights and a blue reflection part 164 for reflecting blue lights. These red, green and blue reflection parts 162, 163 and 164 are separated each other by partition boards 165 (show as hatched). Liquid crystal materials for reflecting red lights are sealed into the red reflection part 162, liquid crystal materials for reflecting green lights are sealed into the green reflection part 163 and liquid crystal materials for reflecting blue lights are sealed into the blue reflection part 164. By providing a single layer containing a red reflection part 162, a green reflection part 163 and a blue reflection part 164, the liquid crystal panel 160 can become thinner.

While several embodiments of the invention have been described in detail herein by referring to FIG. 1 through FIG. 17, it is to be understood that the invention is not intended to be limited to those embodiments and that various modifications and changes to those embodiments can be made in accordance with specific applications of the image picking-up and displaying device.

According to the invention, it is advantageously possible to make the size of the image picking-up and displaying device much smaller.

1. An image displaying and picking-up device comprising:
a liquid crystal panel;
an image picking-up component located at the backside of the said liquid crystal panel;
a light shutter located between the said liquid crystal panel and the said image picking-up component, the said light shutter having a first mode for passing a certain amount of the light and a second mode for passing the less amount of the light than the said certain amount of the light passed in the said first mode; and
a switching means for switching a portion of the said light shutter to one of the said first and second modes wherein the said portion of the said light shutter overlaps with the said image picking-up component in such direction that the said image picking-up component may pick up images.

2. An image displaying and picking-up device as claimed in claim 1, characterized in that the said image displaying and picking-up device further comprises a backlight means for emitting red lights, green lights and blue lights from the backside of the said liquid crystal panel toward said liquid crystal panel.

3. An image displaying and picking-up device as claimed in claim 2, characterized in that the said image displaying and picking-up device further comprises a first light reflection member for reflecting the light emitted by the said backlight means toward the said liquid crystal panel.

4. An image displaying and picking-up device as claimed in claim 3, characterized in that the said light shutter and the said first light reflection member are integrally constructed.

5. An image displaying and picking-up device as claimed in claim 3 or 4, characterized in that the said image displaying and picking-up device further comprises a second light reflection member located at the backside of the said first light reflection member.

6. An image displaying and picking-up device as claimed in any one of claims 2 to 5, characterized in that the said backlight means comprises LEDs for emitting each of red light, green light and blue light.

7. An image displaying and picking-up device as claimed in any one of claims 2 to 5, characterized in that the said backlight means comprises fluorescent lamps for emitting each of red light, green light and blue light.

8. An image displaying and picking-up device as claimed in any one of claims 1 to 7, characterized in that the said light shutter comprises polymer dispersed liquid crystal materials.

9. An image displaying and picking-up device as claimed in claim 1, characterized in that the said liquid crystal panel comprises a red reflection member for reflecting red components of light, a green reflection member for reflecting green components of light and a blue reflection member for reflecting blue components of light.

10. An image displaying and picking-up device as claimed in claim 9, characterized in that the said red reflection member, the said green reflection member and the said blue reflection member are constructed in such multiple layers that are separated each other on the said liquid crystal panel.

11. An image displaying and picking-up device as claimed in claim 9, characterized in that the said red reflection member, the said green reflection member and the said blue reflection member are constructed in a single layer on the said liquid crystal panel.

12. An image displaying and picking-up device as claimed in any one of claims 9 to 11, characterized in that the said image displaying and picking-up device further comprises a light absorption member for absorbing lights that have passed through the said liquid crystal panel.

13. An image displaying and picking-up device as claimed in claim 12, characterized in that the said liquid absorption member and the said light shutter are integrally constructed.
